(19) United States
(12) Patent Application Publication
(10) Pub. No.: US 2024/0012270 A1
(43) Pub. Date: Jan. 11, 2024

(54) ADJUSTABLE OUT-OF-FOCUS GLASSES

(71) Applicant: Plum Needle Technology Inc., Irvine, CA (US)

(72) Inventor: Wenge Peng, Irvine, CA (US)

(21) Appl. No.: 17/859,503

(22) Filed: Jul. 7, 2022

(51) Int. Cl. G02C 7/08; G02C 7/06

(52) U.S. Cl. CPC G02C 7/086; G02C 7/066; G02C 2200/02

(57) ABSTRACT

A pair of out-of-focus glasses include a glasses frame and glasses legs hinged to two ends of the glasses frame. Two inner lenses and two outer lenses are symmetrically arranged on the lower end of the glasses frame, the outer lenses are located away from the glasses legs and detachably connected with the glasses frame, and the inner lenses can be adjusted on the glasses frame in the length direction. The outer lenses include a central visible area and a multi-point out-of-focus area surrounding the central visible area, wherein a plurality of micro convex lenses is distributed in the multi-point out-of-focus area in a multi-circular-ring-shaped array. In one embodiment, the outer lenses and the inner lenses are designed by adopting an Alveraz free-form surface and can be adjusted from 0 to −6D.

### FIELD OF THE INVENTION

The present invention relates to myopia prevention and control, and more particularly relates to out-of-focus glasses that can be intelligently adjusted.

### BACKGROUND OF THE INVENTION

Myopia refers to a refraction state that parallel light rays are focused in front of the retina after passing through an eyeball refraction system in a relaxed state. After correction is carried out by wearing glasses, the focus falls on the retina, but objects on the two sides are presented behind the retina. The eyeballs have the characteristic of focusing growth, namely, in order to see the objects clearly, the rear images can be “found,” so that the eye axis is prolonged, and degree of myopia increases.

The global myopia rate is high, and the myopia pathogenesis is not clear yet. Methods for controlling myopia in current market includes: (1) External environment methods: the methods are to increase outdoor activities and relax ciliary muscles, but the myopia rate is high due to the fact that the time for participating in the outdoor activities is insufficient; (2) Drug control methods: ciliary muscles can be paralyzed by atropine to reduce its adjusting force to control myopia. However, when using the atropine for a long period of time, a side effect of xerophthalmia can be generated. Also, improper usage of atropine can cause toxic reaction, so it is not approved by FDA; (3) Methods for improving the contrast with Gabor glasses and other glasses that can change focus; and (4) Optical correction methods: such as out-of-focus glasses and corneal shaping glasses. The principle is a peripheral myopia out-of-focus theory, namely, a multi-point optical convex lens is adopted on the periphery of the lens, and the incident light passing through the peripheral lens can be focused in front of the peripheral retina. When a signal is given, the retina can lean forward to achieve the effect of out-of-focus myopia, and the occurrence of myopia is delayed.

At present, out-of-focus glasses on the market include: Zeiss MyoVision, HOYA MyoSmart and ESSILOR STELLEST. These glasses are disadvantageous because: (1) poor control of the eye axis; the effective control rate is only up to 68%; (2) the eyesight (contrast sensitivity) cannot be improved, and ciliary muscle spasm cannot be eliminated; (3) each lens is designed into a fixed single-piece out-of-focus lens that cannot achieve zooming, and the curvature of the peripheries of the lenses is steep without transition, so the lens is not smooth enough.

Also, the wearing experience is slightly uncomfortable. The peripheral view is slightly blurred when looking at the front. A mosaic feeling is generated when looking at the side, and dizziness and mosaic-like feeling are generated when the eyes rotate.

Therefore, there remains a need for a new and improved out-of-focus glasses which can control eye axis and improve the eyesight need, as well as enhancing wearing experience.

### SUMMARY OF THE INVENTION

The present invention includes a pair of adjustable out-of-focus glasses, which can overcome the problems and shortcomings stated above. Smooth change of curvature of an out-of-focus surface can be controlled by a gentle movement of inner lenses, so wearing comfortability is enhanced. Through training, an eye axis growth rate can be controlled at 75%, and the contrast sensitivity and eyesight can be also improved.

In one aspect, a pair of adjustable out-of-focus glasses may include a glasses frame and glasses legs hinged to two ends of the glasses frame. Two inner lenses and two outer lenses are symmetrically arranged on a lower end of the glasses frame, and the outer lenses are located away from the glasses legs. The outer lenses are detachably connected with the glasses frame, and the inner lenses can be adjusted on the glasses frame in a length direction.

In one embodiment, the outer lenses and the inner lenses are designed by adopting an Alveraz free-form surface and can be adjusted from 0 to −6D. The inner lenses include a central visible area and a multi-point out-of-focus area surrounding the central visible area, wherein a plurality of micro convex lenses is distributed in the multi-point out-of-focus area in a multi-circular-ring-shaped array.

In another embodiment, the diameter of the central visible area is 9 mm, the diameter of the micro convex lens is 1 mm, the distance between adjacent micro convex lenses in the same circular ring is 1 mm, and the distance between the micro convex lenses in adjacent circular rings is 2 mm.

In still another embodiment, the top ends of the inner lenses have magnetic fixing pieces, and the glasses frame also has corresponding magnetic pieces used for connecting with the magnetic fixing pieces of the inner lenses.

In a further embodiment, the glasses frame internally has a micro motor, a battery used for supplying power and a control mainboard; and the motor is used for driving the magnetic pieces to move in the length direction of the glasses frame.

In still a further embodiment, clamping blocks are fixedly arranged at the top ends of the outer lenses, and clamping grooves that are matched with the clamping blocks are formed in the bottom end of the glasses frame. The lower end of the glasses frame has nose pads located between the two inner lenses, and the top ends of the nose pads are connected with the glasses frame through a magnetic attraction manner. It is important to note that each of the inner lenses is oval-shaped, and length of the major axis of the oval-shaped inner lenses is 11-13 mm, and the length of the minor axis of the oval-shaped inner lenses is 9 mm.

Compared with the prior art, the out-of-focus glasses in the present invention is advantageous because: (1) a plurality of micro convex lenses distributed in an array form an inner lens, so the ciliary muscle is continuously trained to eliminate ciliary muscle spasm through dynamic zooming movement, and the myopia is controlled; (2) the detachable inner lens, outer lens and nose pads are adopted in the present invention, so adjustment and customization can be carried out according to the actual condition of a user, and the needs of different users can be satisfied; (3) the micro-scale movement of the inner lens is utilized, thus the smooth change of the curvature of the out-of-focus glasses is achieved, and the user's wearing comfortability is enhanced; and (4) when the glasses of the present invention are used for training for a long time, the growth rate of the axis of the eyes can be controlled to be 75%, the contrast sensitivity can be improved, as well as the eyesight.

### BRIEF DESCRIPTION OF THE DRAWINGS

FIG. 1 is schematic view of the adjustable out-of-focus glasses in the present invention.

FIG. 2 is schematic view of the inner lenses of the adjustable out-of-focus glasses in the present invention.

FIG. 2a is schematic view of the oval-shaped inner lenses of the adjustable out-of-focus glasses in the present invention.

FIG. 2b is a schematic view of the out-of-focus glasses in the present invention about the distances between the inner lenses and outer lenses.

FIG. 3 is an internal structure of the glass frame of the adjustable out-of-focus glasses in the present invention.

FIG. 4 is a schematic view of the integration of the inner lenses and glasses frame of the adjustable out-of-focus glasses in the present invention.

FIG. 5 is a schematic view of the integration of the inner lenses and outer lenses of the adjustable out-of-focus glasses in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

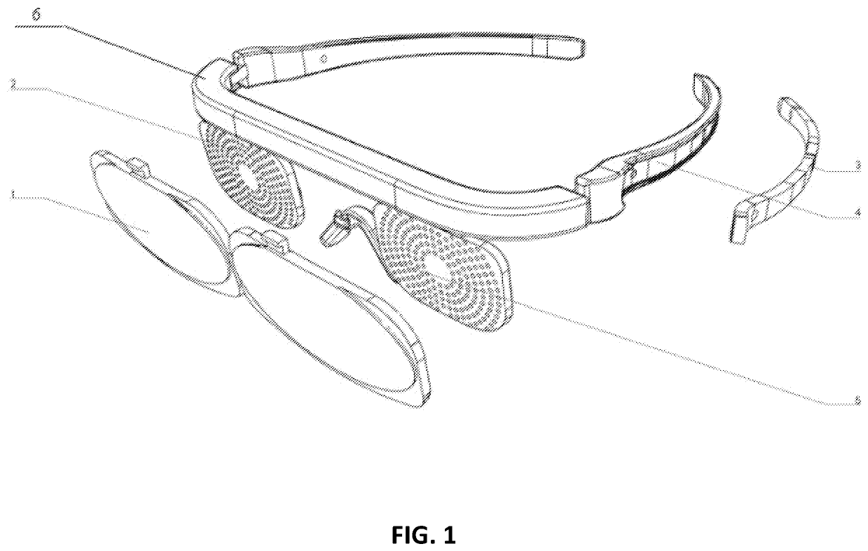

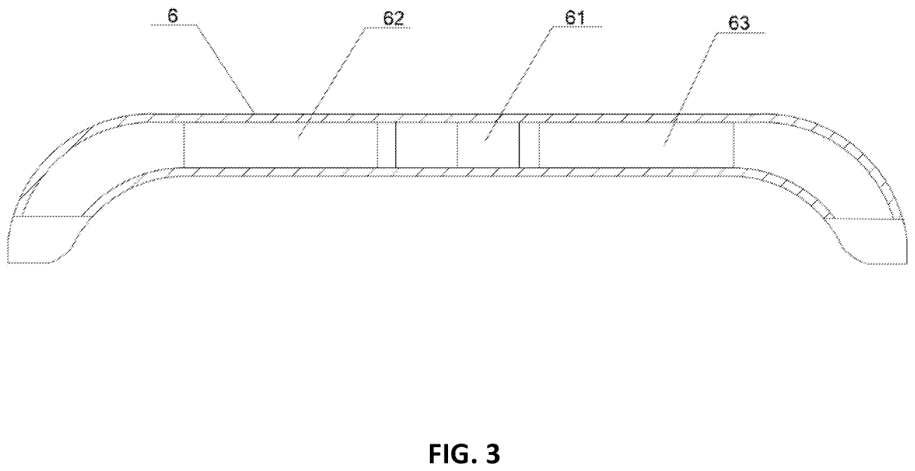

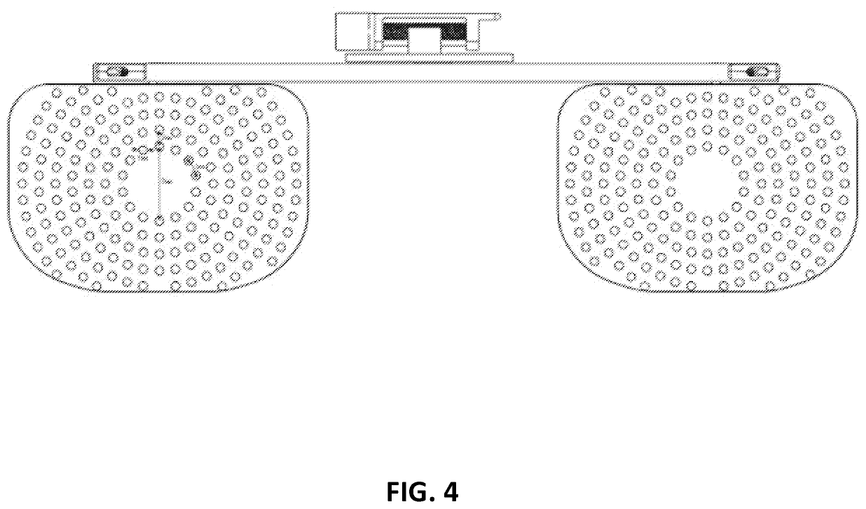

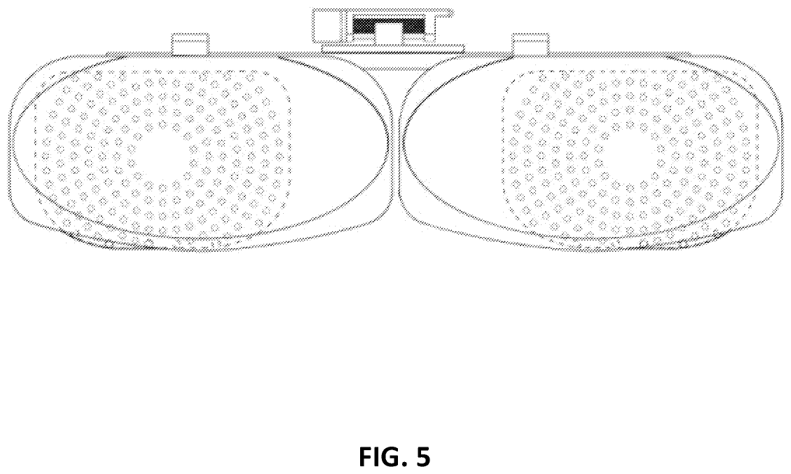

In one aspect, as shown in FIGS. 1 to 5, an adjustable out-of-focus glasses in the present invention may include a glasses frame 6 and glasses legs 4 hinged to two ends of the glasses frame 6; and two inner lenses 2 and two outer lenses 1 are symmetrically arranged on the lower end of the glasses frame 6. The outer lenses 1 are located away from the glasses legs 4, and detachably connected with the glasses frame 6. The inner lenses 2 can be adjusted on the glasses frame 6 in a length direction.

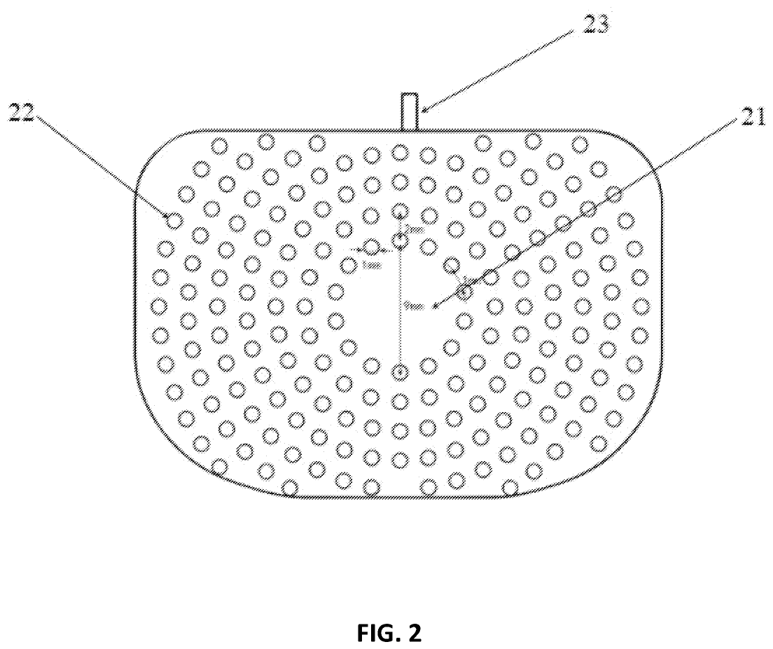

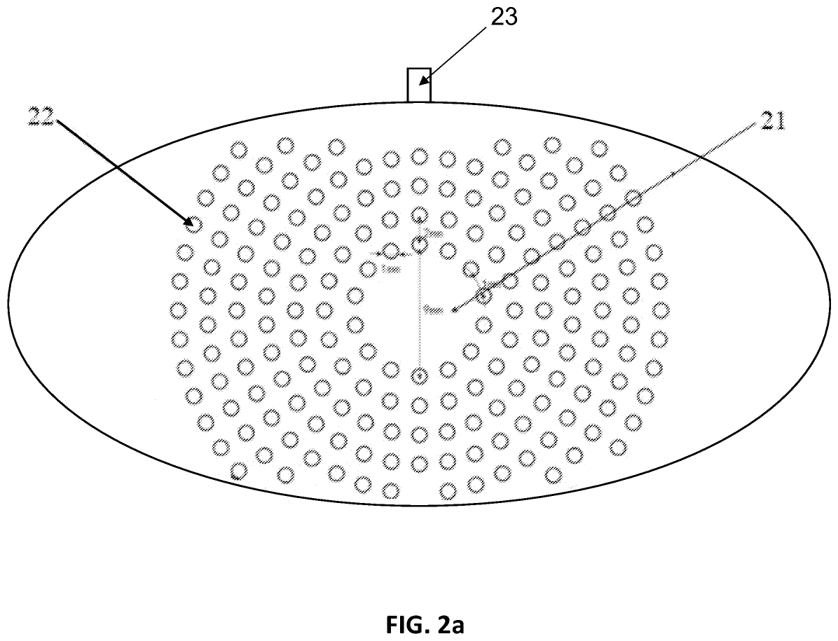

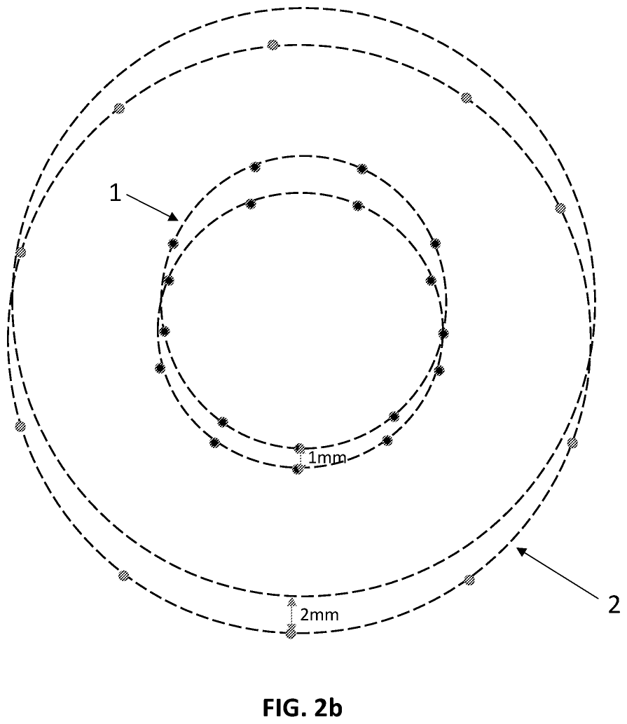

The outer lenses 1 and the inner lenses 2 are designed by adopting an Alveraz free-form surface and can be adjusted from 0 to −6D. The inner lenses may include a central visible area 21 and a multi-point out-of-focus area 22 surrounding the central visible area 21, wherein a plurality of micro convex lenses are distributed in the multi-point out-of-focus area 22 in a multi-circular-ring-shaped array. It is important to note that each of the inner lenses 2 is oval-shaped as shown in FIG. 2a. In one embodiment, the length of the major axis of the oval-shaped inner lenses is 11-13 mm, and the length of the minor axis of the oval-shaped inner lenses is 9 mm.

It is also important to note that in the present invention, each micro convex lens forms a myopia out-of-focus light band in front of the retina to form a myopia out-of-focus area in front of the retina, and the luminosity of each micro convex lens is calculated elaborately to ensure that the distances between the generated myopia out-of-focus areas and the retinas of the eyeballs are generally consistent regardless of closing to the central areas beside the retinas or being far away from the near equator (fornix) part of the centers of the retinas, namely, the amount of myopia out-of-focus slowing signals is the same without being influenced by the position.

In one embodiment, the diameter of the central visible area 21 is 9 mm, the diameter of each micro convex lens is 1 mm, the distance between adjacent micro convex lenses in the same circular ring is 1 mm, and the distance between the micro convex lenses in adjacent circular rings is 2 mm as shown in FIG. 2b.

In another embodiment, the top ends of the inner lenses 2 has magnetic fixing pieces, and the glasses frame 6 has corresponding magnetic pieces used for connecting with the magnetic fixing pieces of the inner lenses 2.

In still another embodiment, the glasses frame 6 internally has a micro motors 61, a battery 62 used for supplying power and a control mainboard 63, and the motor 61 is used for driving the magnetic pieces to move in the length direction of the glasses frame 6. Through the movement of the inner lenses 2, on one hand, the interpupillary distance can be adjusted, and on the other hand, the curvature of the out-of-focus glasses can be smoothly changed.

In a further embodiment, clamping blocks are fixedly arranged at the top ends of the outer lenses 1, and clamping grooves that are matched with the clamping blocks are formed in the bottom end of the glasses frame 6.

In still a further embodiment, the lower end of the glasses frame 6 has nose pads 5 located between the two inner lenses 2. The top ends of the nose pads 5 are connected with the glasses frame 6 through a magnetic attraction manner. It is noted that the nose pads 5 have several different types, and the adjusting range of the pupil height can range from 20 mm-28 mm. In order to improve the wearing comfortability, protection belts 3 made of a silica gel material are arranged on the outer sides of the glasses legs 4.

Compared with the prior art, the out-of-focus glasses in the present invention is advantageous because: (1) a plurality of micro convex lenses distributed in an array form an inner lens, so the ciliary muscle is continuously trained to eliminate ciliary muscle spasm through dynamic zooming movement, and the myopia is controlled; (2) the detachable inner lens, outer lens and nose pads are adopted in the present invention, so adjustment and customization can be carried out according to the actual condition of a user, and the needs of different users can be satisfied; (3) the micro-scale movement of the inner lens is utilized, thus the smooth change of the curvature of the out-of-focus glasses is achieved, and the user's wearing comfortability is enhanced; and (4) when the glasses of the present invention are used for training for a long time, the growth rate of the axis of the eyes can be controlled to be 75%, the contrast sensitivity can be improved, as well as the eyesight.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A pair of adjustable out-of-focus glasses comprising a glasses frame and glasses legs hinged to two ends of the glasses frame, and two inner lenses and two outer lenses are symmetrically arranged on the lower end of the glasses frame,
wherein the outer lenses are located away from the glasses legs and detachably connected with the glasses frame, and the inner lenses (2) can be adjusted on the glasses frame in a length direction;
wherein the inner lenses comprise a central visible area and a multi-point out-of-focus area surrounding the central visible area, and a plurality of micro convex lenses are distributed in the multi-point out-of-focus area in a multi-circular-ring-shaped array;
wherein each of the inner lenses is oval-shaped, and length of the major axis of the oval-shaped inner lenses is 11-13 mm, and the length of the minor axis of the oval-shaped inner lenses is 9 mm.

2. The pair of adjustable out-of-focus glasses of claim 1, wherein the outer lenses and the inner lenses are designed by adopting an Alveraz free-form surface and can be adjusted from 0 to −6D,

3. The pair of adjustable out-of-focus glasses of claim 1, wherein the diameter of the central visible area is 9 mm, the diameter of each micro convex lens is 1 mm, the distance between adjacent micro convex lenses in the same circular ring is 1 mm, and the distance between the micro convex lenses in adjacent circular rings is 2 mm.

4. The pair of adjustable out-of-focus glasses of claim 1, wherein the top ends of the inner lenses has magnetic fixing pieces, and the glasses frame internally has corresponding magnetic pieces used connecting with the magnetic fixing pieces of the inner lenses.

5. The pair of adjustable out-of-focus glasses of claim 2, wherein the top ends of the inner lenses has magnetic fixing pieces, and the glasses frame internally has corresponding magnetic pieces used connecting with the magnetic fixing pieces of the inner lenses.

6. The pair of adjustable out-of-focus glasses of claim 1, wherein the glasses frame internally has a micro motor, a battery used for supplying power and a control mainboard, and the motor is used for driving the magnetic pieces to move in the length direction of the glasses frame.

7. The pair of adjustable out-of-focus glasses of claim 1, wherein clamping blocks are fixedly arranged at the top ends of the outer lenses, and clamping grooves that are matched with the clamping blocks are formed in the bottom end of the glasses frame.

8. The pair of adjustable out-of-focus glasses of claim 1, wherein the lower end of the glasses frame is further connected with nose pads located between the two inner lenses, and the top ends of the nose pads are connected with the glasses frame through a magnetic attraction manner.
